(19) United States
(12) Patent Application Publication
(10) Pub. No.: US 2025/0067852 A1
(43) Pub. Date: Feb. 27, 2025

(54) OPTICAL DEVICE AND LIDAR DEVICE INCLUDING THE SAME

(71) Applicant: Samsung Electronics Co., Ltd., Suwon-si (KR)

(72) Inventors: Changgyun SHIN, Suwon-si (KR); Eunkyung LEE, Suwon-si (KR)

(73) Assignee: Samsung Electronics Co., Ltd., Suwon-si (KR)

(21) Appl. No.: 18/432,391

(22) Filed: Feb. 5, 2024

(30) Foreign Application Priority Data
Aug. 24, 2023 (KR) 10-2023-0111517

(51) Int. Cl. G01S 7/481

(52) U.S. Cl. CPC G01S 7/4818; G01S 7/4814; G01S 7/4816

(57) ABSTRACT

An optical device according to various example embodiments includes a first waveguide including a first core, a second waveguide including a second core spaced apart from the first waveguide and having a refractive index less than that of the first core, and a third waveguide disposed between the first waveguide and the second waveguide and including a third core having a refractive index less than the refractive index of the first core and greater than the refractive index of the second core.

### CROSS-REFERENCE TO RELATED APPLICATION

This application is based on and claims priority under 35 U.S.C. § 119 to Korean Patent Application No. 10-2023-0111517, filed on Aug. 24, 2023, in the Korean Intellectual Property Office, the disclosure of which is incorporated by reference herein in its entirety.

### BACKGROUND

Various example embodiments relate to an optical device and a light radar (LiDAR) device including the optical device.

The applicability of silicon photonics devices that may be implemented using a semiconductor CMOS process is expanding to various fields, such as optical sensors, optical links, optical computing, and/or optical memory. This may be due to silicon photonics' characteristics such as light transmission, branching, amplification, and modulation.

Silicon, which is mainly used in photonics devices, may transmit light of a near-infrared wavelength with low loss, but as the transmission distance increases, light loss occurs as the light travels through a waveguide. Therefore, amplification of light is necessary or desirable, and light of wavelengths in the visible light range is absorbed. On the other hand, silicon nitride, which may be used from a visible light region to a near-infrared region as an optical waveguide structure, has a limitation in that it is difficult to implement an electro-optic modulator, which is essential in high-speed devices, due to silicon nitride's electrical insulation properties. Therefore, in order to compensate or improve upon for the drawbacks between these two materials, a technology to freely control the optical waveguide between silicon and silicon nitride is needed or being pursued.

### SUMMARY

Provided are an optical device with improved light efficiency and/or a LIDAR device including the same.

Additional aspects will be set forth in part in the description which follows and, in part, will be apparent from the description, or may be learned by practice of various example embodiments.

According to an aspect of the disclosure, an optical device includes a first waveguide including a first core, a second waveguide spaced apart from the first waveguide and including a second core having a refractive index less than that of the first core, and a third waveguide including a third core between the first waveguide and the second waveguide and having a refractive index that is less than the refractive index of the first core and greater than the refractive index of the second core.

Alternatively or additionally according to various example embodiments, an optical integrated circuit includes a substrate and an optical device on the substrate, wherein the optical device includes a first waveguide including a first core, a second waveguide spaced apart from the first waveguide and including a second core having a refractive index less than that of the first core, and a third waveguide between the first waveguide and the second waveguide and includes a third core having a refractive index that is less than the refractive index of the first core and greater than the refractive index of the second core.

Alternatively or additionally according to various example embodiments, a light radar (LIDAR) device includes a light transmitter configured to irradiate light to an object, a light receiver configured to receive light reflected from the object, a processor configured to perform an operation to obtain information about the object from the light received by the light receiver, and an optical device configured to provide a path for light to travel within the light transmitter and/or the light receiver, wherein the optical device includes a first waveguide including a first core, a second waveguide spaced apart from the first waveguide and including a second core having a refractive index less than that of the first core, and a third waveguide between the first waveguide and the second waveguide and includes a third core having a refractive index that is less than the refractive index of the first core and greater than the refractive index of the second core.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram showing an optical device according to various example embodiments;

FIG. 2 is a diagram showing an optical device according to various example embodiments;

FIG. 3 is a diagram showing an optical device according to various example embodiments;

FIG. 4 is a diagram showing an optical device according to various example embodiments;

FIG. 5 is a diagram showing an optical device according to various example embodiments;

FIG. 6A is a diagram showing light loss according to a gap between a first waveguide and a second waveguide;

FIG. 6b is a diagram showing a simulation result of light propagation according to a gap between a first waveguide and a second waveguide;

FIG. 7 is a diagram briefly showing a LiDAR device according to various example embodiments;

FIG. 8 is a block diagram showing a schematic configuration of an electronic device including a LIDAR device according to various example embodiments;

FIGS. 9 and 10 show a side view and a top view, respectively, of conceptual diagrams showing a case when a LIDAR device according to various example embodiments is applied to a vehicle; and

FIG. 11 is a block diagram conceptually showing an example configuration of an optical integrated circuit according to various example embodiments.

### DETAILED DESCRIPTION

Reference will now be made in detail to various embodiments, examples of which are illustrated in the accompanying drawings, wherein like reference numerals refer to like elements throughout. In this regard, example embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

Hereinafter, optical devices and/or LiDAR devices including the same according to various embodiments will be described in detail with reference to the accompanying drawings. In the drawings, like reference numerals refer to like elements throughout, and sizes of elements in the drawings may be exaggerated for clarity and convenience of explanation. In addition, example embodiments may be variously modified and may be embodied in many different forms.

When an element or layer is referred to as being “on” or “above” another element or layer, the element or layer may be directly on another element or layer or intervening elements or layers. The singular forms are intended to include the plural forms as well, unless the context clearly indicates otherwise. When a part “comprises” or “includes” an element in the specification, unless otherwise defined, it is not excluding other elements but may further include other elements.

The term “above” and similar directional terms may be applied to both singular and plural. With respect to operations that constitute a method, the operations may be performed in any appropriate sequence unless the sequence of operations is clearly described or unless the context clearly indicates otherwise.

Connections or connection members of lines between components shown in the drawings illustrate functional connections and/or physical or circuit connections, and the connections or connection members may be represented by replaceable or additional various functional connections, physical connections, or circuit connections in an actual device.

All examples or example terms are simply used to explain in detail the technical scope of the disclosure, and thus, the scope of the disclosure is not limited by the examples or the example terms as long as it is not defined by the claims.

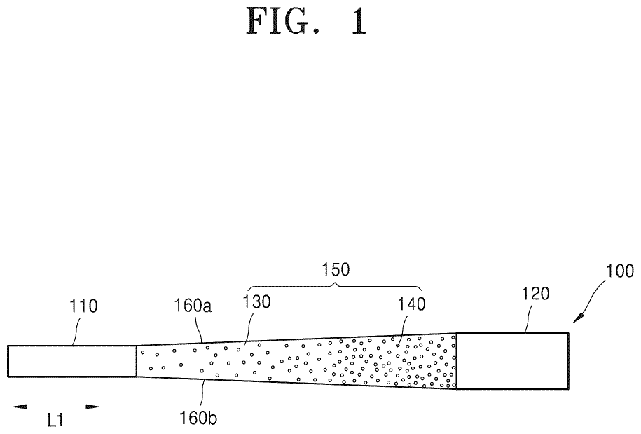

FIG. 1 is a diagram showing an optical device 100 according to various example embodiments. FIG. 1 is a plan view illustrating an optical device 100.

Referring to FIG. 1, the optical device 100 may include a first waveguide 110 including a first core, a second waveguide 120 disposed apart from the first waveguide 110 and including a second core having a refractive index less than that of the first core, and a third waveguide 150 disposed between the first waveguide 110 and the second waveguide 120 and including a third core 130 having a refractive index less than that of the first core and greater than that of the second core.

Light may be incident on or into the optical device 100 on one end of the optical device 100, may travel in a length direction L1 of the optical device 100, and then may be emitted to the outside through another end of the optical device 100. For example, the length direction L1 of the optical device 100 may be the same as the direction of light propagation. The optical device 100 or portions of the optical device 100 may have various shapes, such as one or more of a polygonal pillar, a cylinder, an elliptical pillar, a tapered pillar, or a hexahedron.

The first waveguide 110 may include a first core having a refractive index greater than that of the second core and the third core 130. The first core may include, for example, silicon or a Group III-V semiconductor material. If the first core includes silicon or primary includes silicon, the refractive index of the first core is about 3.4.

The second waveguide 120 may include a second core having a refractive index less than those of the first core and the third core 130. The second core may include, for example, one or more of silicon nitride, silicon oxide, zinc oxide, or titanium oxide. If the second core includes silicon nitride or primarily includes silicon nitride, the refractive index of the second core is about 2.

For example, the first core may include Si and the second core may include silicon nitride (Si₃N₄). Alternatively or additionally, for example, the first core may include Si and the second core may include silicon oxide (SiO₂). Alternatively or additionally, for example, the first core may include GaAs and the second core may include silicon nitride (Si₃N₄). However, example embodiments are not limited to this, and the first core and the second core may each include different materials having different refractive indices.

The first waveguide 110 may include a material that is configured to guide light in the near-infrared band with a wavelength of about 1 μm or above. The second waveguide 120 may include a material that is configured to guide light in the near-infrared and visible light bands with a wavelength of about 1 μm or less. The second waveguide 120 may be configured to guide light of high intensity. The second waveguide 120 may include a material that has little or a reduced nonlinear optical effect.

The first waveguide 110 and the second waveguide 120 may be spaced apart at a certain interval. A gap between the first waveguide 110 and the second waveguide 120 may be, for example, 10 μm or more. In some example embodiment, the gap between the first waveguide 110 and the second waveguide 120 may be, for example, 100 μm or more. If the gap between the first waveguide 110 and the second waveguide 120 is narrow, it may be difficult to guide light due to the difference in refractive index between the first core of the first waveguide 110 and the second core of the second waveguide 120. For example, in a direct optical waveguide from the first waveguide 110 including the first core having a high refractive index to the second waveguide 120 including the second core having a low refractive index, light may not couple or even if coupled, the coupling efficiency is very low.

The third waveguide 150 may include the third core 130 having a less refractive index than the first core and a greater refractive index than the second core. The third waveguide 150 is disposed between the first waveguide 110 and the second waveguide 120 to enable optical waveguide between the first waveguide 110 and the second waveguide 120 with a large refractive index difference.

The refractive index of the third core 130 may vary depending on a position within the third waveguide 150. The refractive index of the third core 130 may decrease intermittently and/or continuously from an interface where the third waveguide 150 contacts the first waveguide 110 to an interface where the third waveguide 150 contacts the second waveguide 120. For example, the refractive index of the third core 130 may decrease linearly and/or parabolically and/or exponentially and/or logarithmically and/or monotonically.

The third waveguide 150 may further include or may define or surround pores 140 formed inside the third core 130. Even though the third waveguide 150 includes or defines or surrounds the pores 140 therein, light loss is not significant. The pores 140 may be nanopores and/or micropores. The nanopores have a structure with channels or pores with a diameter of nanometers, and the micropores have a structure with channels or pores with a diameter of micrometers.

The density of the pores 140 may vary depending on the location within the third waveguide 150. As described herein, I density of the pores 140 refers to the number of pores 140 included in a unit volume of the core material. The density of the pores 140 may increase intermittently or continuously from the interface where the third waveguide 150 contacts the first waveguide 110 to the interface where the third waveguide 150 contacts the second waveguide 120. For example, the density of the pores 140 may increase linearly and/or parabolically and/or exponentially and/or logarithmically and/or monotonically. As the density of the pores 140 included in the third waveguide 150 changes, the refractive index of the third core 130 may vary depending on the position within the third waveguide 150. As the density of the pores 140 included in the third waveguide 150 increases, the refractive index of the third core 130 may decrease depending on the position within the third waveguide 150.

For example, the third waveguide 150 may have a tapered shape. The size (or, the cross-sectional area) of the third waveguide 150 may increase from the interface where the third waveguide 150 contacts the first waveguide 110 to the interface where the third waveguide 150 contacts the second waveguide 120. In this case, a width of the second waveguide 120 may be greater than a width of the first waveguide 110. However, the third waveguide 150 is not limited to this and may have, or may have portions of, various shapes such as one or more of a polygonal pillar, a cylinder, an elliptical pillar, or a hexahedron.

The optical device 100 may include a first total reflection surface 160a and a second total reflection surface 160b. A cladding layer (not shown) surrounding the core may be provided on the first total reflection surface 160a and the second total reflection surface 160b. The cladding layer may include a material having a less refractive index than the core.

The interface between the first waveguide 110 and the third waveguide 150 and the interface between the second waveguide 120 and the third waveguide 150 are shown in a direction perpendicular to the waveguide direction, but depending on the light input and output, the interfaces may have a certain angle other than perpendicular to the waveguide direction.

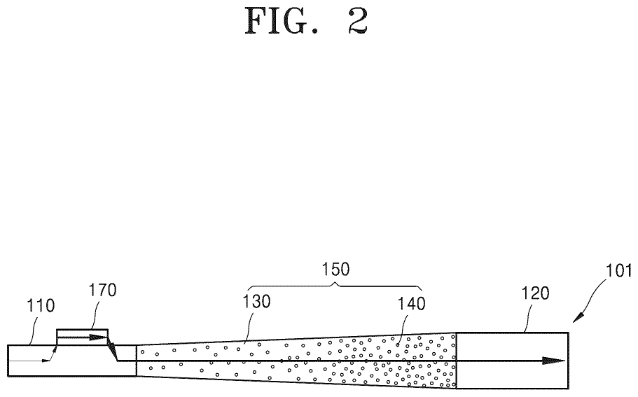

FIG. 2 is a diagram showing an optical device 101 according to various example embodiments.

Referring to FIG. 2, the optical device 101 may include a first waveguide 110, a second waveguide 120 that is spaced apart from the first waveguide 110, a third waveguide 150 disposed between the first waveguide 110 and the second waveguide 120 and including a third core 130 and pores 140, and an amplifier 170. The optical device 101 may be the same as the optical device 100 of FIG. 1 except that the optical device 101 further includes the amplifier 170.

The amplifier 170 may be placed on (e.g., directly on) the first waveguide 110. If the amplifier 170 is disposed on the first waveguide 110, light passes through the first waveguide 110 and is amplified through the amplifier 170, and then, the light is emitted sequentially passing through the third waveguide 150 and the second waveguide 120. However, example embodiments are not limited thereto and the amplifier 170 or an additional amplifier may be disposed on the third waveguide 150. If the amplifier 170 is placed on the third waveguide 150, light passes through the first waveguide 110 and the third waveguide 150, is amplified through the amplifier 170, and then, is emitted passing through the second waveguide 120. The amplifier 170 may be disposed on the first waveguide 110 and/or the third waveguide 150 to amplify the output of light. Amplified light may be transmitted through the second waveguide 120 without loss or deformation.

The amplifier 170 may have a greater width than that of the first waveguide 110 or the third waveguide 150. In this way, leakage of light transmitted through the first waveguide 110 or the third waveguide 150 may be reduced.

The amplifier 170 may include, for example, a lower clad layer, an active layer, and an upper clad layer. The lower clad layer, the active layer, and the upper clad layer may independently or concurrently include a Group III-V compound semiconductor material and/or a Group II-VI compound semiconductor material. The active layer may include, for example, one or more of InGaAs, InGaNAs, InGaAsP, or InAlGaAs. The lower clad layer and the upper clad layer may include a semiconductor material having a band gap greater than that of the active layer. The lower clad layer and the upper clad layer may include, for example, one or more of GaAs, GaP, AlGaAs, InGaP, GaAs, or InP. The material of the amplifier 170 may be selected according to a wavelength (energy band gap) of light to be amplified. For example, when amplifying light having a wavelength of 1.55 μm, the upper and lower clad layers and the active layer may include an InP/InGaAs material.

The amplifier 170 may include a semiconductor optical amplifier and/or an ion-doped (or ion-implanted) amplifier. The semiconductor optical amplifier does not require or utilize a separate exiting laser and may amplify an optical signal by applying an electric field to both sides of the optical device 101. There are at least two types of semiconductor optical amplifiers, for example, a Fabry-Perot Amplifier (FPA) type and a Traveling Wave Amplifier (TWA) type. Regarding the FPA type, a density inversion occurs in a conduction band, which is a high energy level, in response to an injection current, and a stimulated emission occurs by transition to a valence band, which is a low energy level, and may be amplified by a resonator. The TWA type may have a structure in which anti-reflection coatings are applied on both ends of the semiconductor laser to suppress reflection on the emission surface and suppress the resonance phenomenon, thereby widening the gain bandwidth compared to the FPA type.

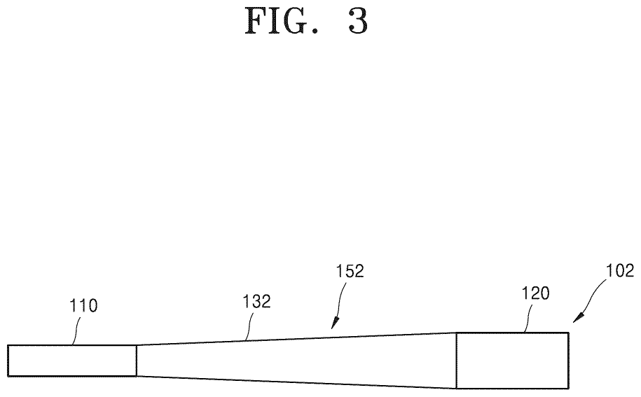

FIG. 3 is a diagram showing an optical device 102 according to various example embodiments.

Referring to FIG. 3, the optical device 102 includes a first waveguide 110, a second waveguide 120 that is spaced apart from the first waveguide 110, and a third waveguide 152 disposed between the first waveguide 110 and the second waveguide 120 and including a third core 132. The first waveguide 110 and the second waveguide 120 may be the same as the first waveguide 110 and the second waveguide 120 of FIG. 1.

The third waveguide 152 may include the third core 132 that has a refractive index less than a first core and a refractive index greater than a second core. The third core 132 may include, e.g., may predominantly include silicon nitride and/or silicon oxide.

A composition ratio or a stoichiometric ratio of a material constituting the third core 132 may vary depending on the location within the third waveguide 152. For example, the third core 132 may include silicon nitride. At this time, the composition ratio of silicon and nitrogen in silicon nitride may vary depending on the location within the third waveguide 152. For example, the nitrogen ratio of silicon nitride may increase intermittently and/or continuously from an interface where the third waveguide 152 contacts the first waveguide 110 to an interface where the third waveguide 152 contacts the second waveguide 120. For example, the nitrogen ratio of silicon nitride may increase linearly and/or parabolically and/or exponentially and/or logarithmically and/or monotonically. As the nitrogen ratio of the silicon nitride included in the third core 132 increases, the refractive index of the third core 132 may decrease intermittently or continuously from the interface where the third waveguide 152 contacts the first waveguide 110 to the interface where the third waveguide 152 contacts the second waveguide 120. For example, the third core 132 may include silicon oxide. At this time, a composition ratio of silicon and oxygen in silicon oxide may vary depending on the location of the third waveguide 152.

The third waveguide 152 is disposed between the first waveguide 110 and the second waveguide 120 to enable optical waveguide between the first waveguide 110 having a large refractive index difference with the second waveguide 120. The third waveguide 152 may not include pores. However, example embodiments are not limited thereto, and the third waveguide 152 may include pores.

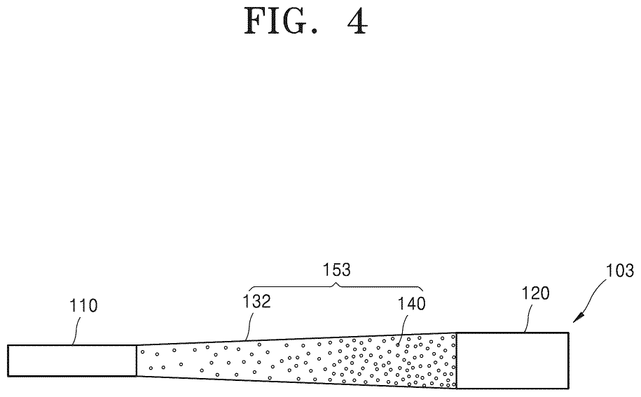

FIG. 4 is a diagram showing an optical device 103 according to various example embodiments.

Referring to FIG. 4, the optical device 103 includes a first waveguide 110 including a first core, a second waveguide 120 that is spaced apart from the first waveguide 110 and including a second core having a refractive index less than that of the first core, and a third waveguide 153 disposed between the first waveguide 110 and the second waveguide 120 and including a third core 132 having a refractive index less than that of the first core and greater than that of the second core and pores 140 formed inside the third core 132. The first waveguide 110, the second waveguide 120, and the pores 140 may be or may have similar structural and/or functional characteristics the same as the first waveguide 110, the second waveguide 120, and the pores 140 of FIG. 1, and the third core 132 may be the same as the third core 132 of FIG. 3. In the description of FIG. 4, descriptions previously given with reference to FIGS. 1 to 3 will be omitted.

The third core 132 may include silicon nitride and/or silicon oxide. At the same time, the third waveguide 153 may include the pores 140.

A composition ratio of materials constituting the third core 132 may vary depending on the location within the third waveguide 153, and the density and size of the pores 140 may also vary depending on the location within the third waveguide 153. The refractive index of the third core 132 may be adjusted by adjusting the composition ratio of the materials constituting the third core 132 and the density and size of the pores 140. The third waveguide 153 is disposed between the first waveguide 110 and the second waveguide 120 to enable optical waveguide between the first waveguide 110 having a large refractive index difference with the second waveguide 120.

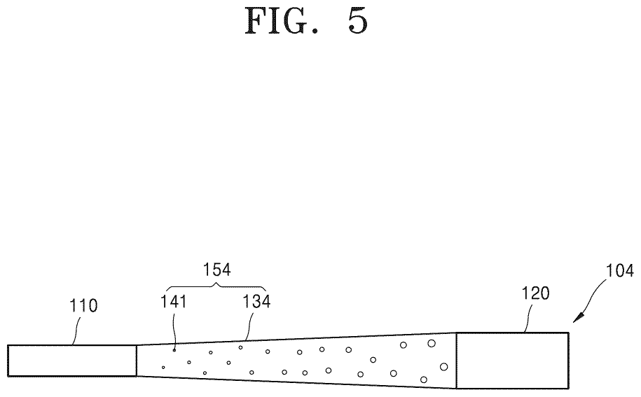

FIG. 5 is a diagram showing an optical device 104 according to various example embodiments.

Referring to FIG. 5, the optical device 104 may include a first waveguide 110 including a first core, a second waveguide 120 spaced apart from the first waveguide 110 and including a second core having a refractive index less than that of the first core, and a third waveguide 154 disposed between the first waveguide 110 and the second waveguide 120 and including a third core 134 and pores 141 formed inside the third core 134. The first waveguide 110 and the second waveguide 120 may be the same as the first waveguide 110 and the second waveguide 120 of FIG. 1, and the third core 134 may be the same as one of the third core 130 of FIG. 1 or the third core 132 of FIG. 3. In the description of FIG. 5, descriptions previously given with reference to FIGS. 1 to 4 will be omitted.

The size of the pores 141 may vary depending on the location within the third waveguide 154. The size of the pores 141 may increase intermittently or continuously from an interface where the third waveguide 154 contacts the first waveguide 110 to an interface where the third waveguide 154 contacts the second waveguide 120. For example, the size of the pores 141 may increase linearly and/or parabolically and/or exponentially and/or logarithmically and/or monotonically. As the size of the pores 141 included in the third waveguide 154 changes, the refractive index of the third core 134 may vary depending on the position within the third waveguide 154. As the size of the pores 141 included in the third waveguide 154 increases, the refractive index of the third core 134 may decrease depending on the position within the third waveguide 154.

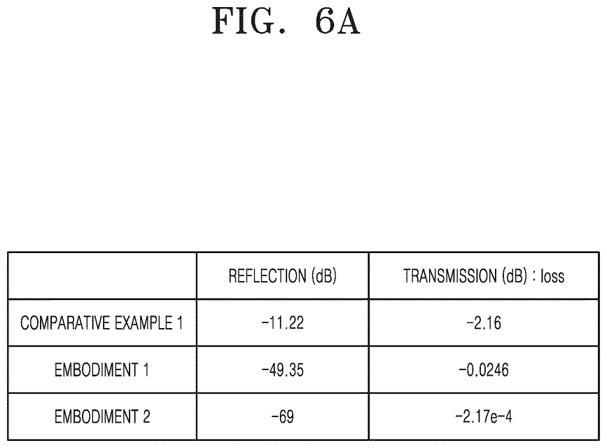

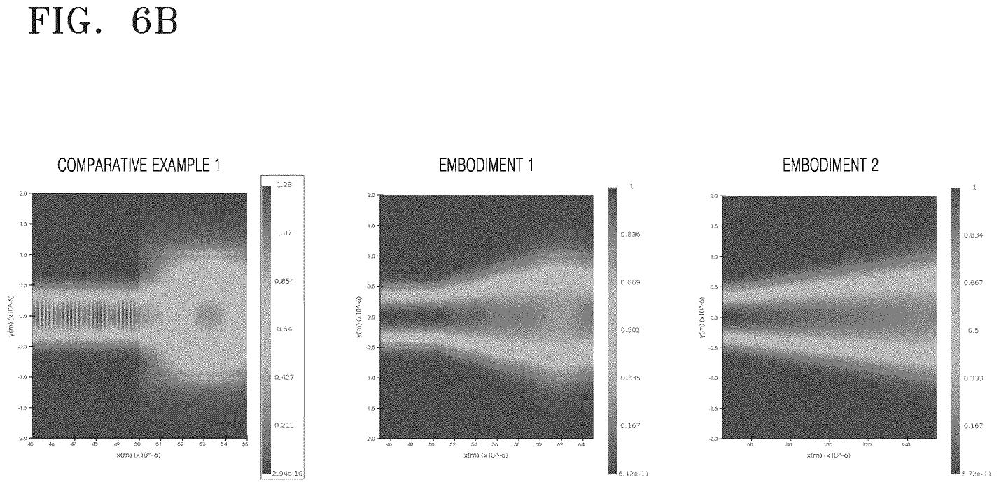

FIG. 6A is a diagram showing light loss according to a gap between a first waveguide and a second waveguide.

FIG. 6B is a diagram showing a simulation result of light propagation according to a gap between the first waveguide and the second waveguide.

Comparative Example 1 shows the amount of reflection and transmission when light is incident on an optical device in which a first waveguide including Si and a second waveguide including Si₃N₄ are in contact, and Embodiment 1 shows the amount of reflection and transmission when light is incident on an optical device in which a first waveguide including Si and a second waveguide including Si₃N₄ are spaced apart at 10 μm intervals, and Embodiment 2 shows the amount of reflection and transmission when light is incident on an optical device in which a first waveguide including Si and a second waveguide including Si₃N₄ are spaced apart at an interval of 100 μm.

Referring to FIG. 6A, it may be seen that in the case of Comparative Example 1, the reflection amount was −11.22 dB and the transmission amount was −2.16 dB, which indicate a large or significant loss of light. In the case of Embodiment 1, the reflection amount is −49.35 dB and the transmission amount is −0.0246 dB, and in the case of Embodiment 2, the reflection amount is −69 dB and the transmission amount is −2.17e-4 dB, thus, it may be confirmed that there is almost no or very little loss of light.

Referring to FIG. 6B, it may be seen that in Comparative Example 1, light of red color does not proceed to the waveguide. In the case of Embodiments 1 and 2, it may be seen that the light of red color travels well through the waveguide. In particular, in the case of Embodiment 2, it may be seen that light travels well without mode change or waveguide loss.

When the first waveguide including Si and the second waveguide including Si₃N₄ are in contact, optical waveguide is difficult due to optical loss, and when the first waveguide including Si and the second waveguide including Si₃N₄ are spaced apart at a certain distance, it may be seen that low-loss waveguiding of high-output light is possible.

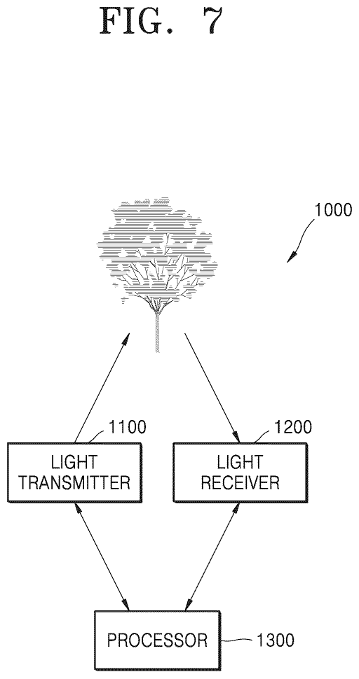

FIG. 7 is a diagram briefly showing a LiDAR device 1000 according to various example embodiments.

As shown in FIG. 7, the LiDAR device 1000 includes a light transmitter 1100 configured to irradiate light to an object, a light receiver 1200 configured to receive light reflected from the object, and a processor 1300 configured to perform an operation so as to obtain information about an object from the light received from the light receiver 1200. The light transmitter 1100 may include a light source that generates light, and a steering unit that steers the light output from the light source toward the object. The LiDAR device 1000 may include an optical device that provides a path for light to travel within the light transmitter 1100 or the light receiver 1200. The LIDAR device 1000 may include an optical device that provides an optical connection between the light source and the steering unit. The optical device may be the same as the optical devices 100, 101, 102, 103, and 104 described with reference to FIGS. 1 to 5. The light transmitter 1100, the light receiver 1200, and the processor 1300 may be implemented as separate devices or as one device.

The light source may be or may include a wavelength-variable light source that may adjust the wavelength of emitted light. A plurality of laser beams may be emitted from the light source, and among the plurality of laser beams, laser beams having optical coherence with each other may be incident on the steering unit. A light source can generate and output light in a plurality of different wavelength bands. In addition, the light source may generate and output pulsed light or continuous light.

The light source may include one or more of a laser diode (LD), an edge emitting laser, a vertical-cavity surface emitting laser (VCSEL), a distributed feedback laser, light-emitting diode (LED), a super luminescent diode (SLD), etc.

The steering unit illuminates the object by changing a direction of light emitted from the light source, and may include an optical phased array element that may adjust the direction of light without mechanical movement. The steering unit may transmit amplified light toward a localized area in front using a one-dimensional and/or two-dimensional scanning method. To this end, the steering unit may sequentially or non-sequentially steer light focused in a narrow region to the front one-dimensional or two-dimensional regions at regular time intervals. For example, the steering unit may be configured to emit laser light from bottom to top or from top to bottom with respect to one-dimensional regions in front. In some examples, the steering unit may be configured to emit laser light from left to right or from right to left with respect to one-dimensional regions in front.

The light receiver 1200 may receive light reflected by an object and generate an electrical signal based on the received light. The light receiver 1200 may include an array of light detection elements. The light receiver 1200 may further include a processing circuit.

The processor 1300 may perform an operation to obtain information about the object from the light received by the light receiver 1200. Also, the processor 1300 may oversee the processing and control of the entire LiDAR device 1000. The processor 1300 may obtain and process information about the object. For example, the processor 1300 may acquire and process 2D or 3D image information. The processor 1300 may generally control the driving of the light transmitter 1100 or the operation of the light receiver 1200. For example, the processor 1300 may control an electrical signal applied to an optical phased array element included in the steering unit. The processor 1300 may also interpret a distance between the object and the LIDAR device 1000, the shape of the target, etc., through the numerical information provided by the light receiver 1200.

The 3D image acquired by the processor 1300 may be transmitted and utilized by another unit. For example, the information may be transmitted to the processor 1300 of an autonomous device, such as a vehicle or drone that employs the LiDAR device 1000. In addition, the information may be utilized in smartphones, mobile phones, personal digital assistants (PDAs), laptops, personal computers (PCs), wearable devices, and other mobile or non-mobile computing devices.

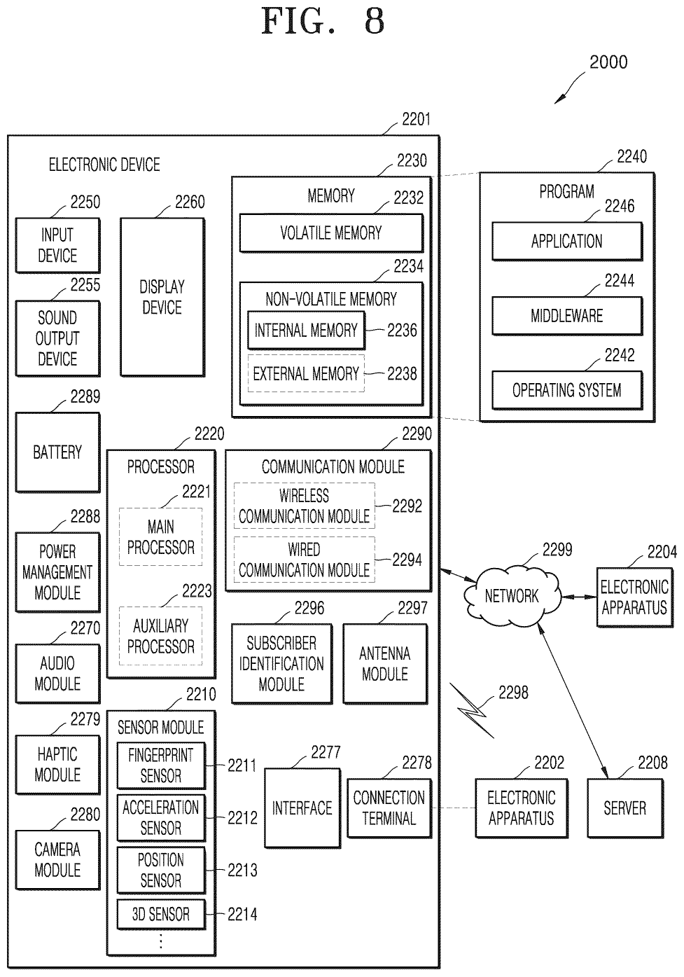

FIG. 8 is a block diagram showing a schematic configuration of an electronic device including a LiDAR device according to various example embodiments.

Referring to FIG. 8, in a network environment 2200, an electronic device 2201 may communicate with another electronic device 2202 through a first network 2298 (a short-range wireless communication network, etc.), and/or may communicate with another electronic device 2204 and/or a server 2208 through a second network 2299 (a long-distance wireless communication network). The electronic device 2201 may communicate with the electronic device 2204 through the server 2208. The electronic apparatus 2201 may include a processor 2220, a memory 2230, an input device 2250, an audio output device 2255, a display device 2260, an audio module 2270, a sensor module 2210, an interface 2277, a haptic module 2279, a camera module 2280, a power management module 2288, a battery 2289, a communication module 2290, a subscriber identification module 2296, and/or an antenna module 2297. In the electronic device 2201, some of these components (e.g., the display device 2260) may be omitted or other components may be added. Some of these components may be implemented as one integrated circuit. For example, a fingerprint sensor 2211 of the sensor module 2210, an iris sensor, an illuminance sensor, etc. may be implemented in a form embedded in the display device 2260 (a display, etc.).

The processor 2220 may execute software (such as a program 2240) to control one or a plurality of other components (hardware, software components, etc.) of the electronic device 2201 connected to the processor 2220, and may perform various data processing or operations. As part of data processing or computation, processor 2220 may load commands and/or data received from other components (the sensor module 2210, the communication module 2290, etc.) into volatile memory 2232, and may process commands and/or data stored in the volatile memory 2232, and store resulting data in a non-volatile memory 2234. The processor 2220 may include a main processor 2221 (a central processing unit, an application processor, etc.) and an auxiliary processor 2223 (a graphics processing unit, an image signal processor, a sensor hub processor, a communication processor, etc.) that may be operated independently or together with the main processor 2221. The auxiliary processor 2223 may use less power than the main processor 2221 and may perform specialized functions.

The auxiliary processor 2223 may control functions and/or states related to some of the components (e.g., the display device 2260, the sensor module 2210, the communication module 2290) of the electronic device 2201 instead of the main processor 2221 while the main processor 2221 is in an inactive state (a sleep state), or together with the main processor 2221 while the main processor 2221 is in an active state (an application execution state). The auxiliary processor 2223 (one or more of an image signal processor, a communication processor, etc.) may also be implemented as part of other functionally related components (one or more of the camera module 2280, the communication module 2290, etc.).

The memory 2230 may store various data required by components (the processor 2220, the sensor module 2276, etc.) of the electronic device 2201. Data may include, for example, input data and/or output data for software (such as the program 2240) and instructions related to the software. The memory 2230 may include volatile memory 2232 and/or a non-volatile memory 2234.

The program 2240 may be stored as software in the memory 2230 and may include an operating system 2242, middleware 2244, and/or an application 2246.

The input device 2250 may receive commands and/or data to be used in components (such as the processor 2220) of the electronic device 2201 from the outside the electronic device 2201 (e.g., a user). The input device 2250 may include one or more of a microphone, a mouse, a keyboard, and/or a digital pen (e.g., a stylus pen, etc.).

The sound output device 2255 may output a sound signal to the outside of the electronic device 2201. The sound output device 2255 may include a speaker and/or a receiver. The speaker may be used for general purposes, such as multimedia playback and/or recording playback, and the receiver may be used to receive incoming calls. The receiver may be integrated as part of the speaker or implemented as a separate, independent device.

The display device 2260 may visually provide information to the outside of the electronic device 2201. The display device 2260 may include a control circuit for controlling a display, a hologram device, or a projector and a corresponding device. The display device 2260 may include a touch circuitry configured to detect a touch, and/or a sensor circuit configured to measure the intensity of force generated by the touch (e.g., a pressure sensor).

The audio module 2270 may convert sound into an electrical signal or, conversely, convert an electrical signal into a sound. The audio module 2270 may obtain a sound through the input device 2250 or may output a sound through a speaker and/or headphone of the sound output device 2255 and/or another electronic device (e.g., the electronic device 2202) directly and/or wirelessly connected to electronic device 2201.

The sensor module 2210 may detect an operating state (power, temperature, etc.) of the electronic device 2201 or an external environmental state (user status, etc.) and may generate an electrical signal and/or data value corresponding to the sensed state. The sensor module 2210 may include a fingerprint sensor 2211, an acceleration sensor 2212, a position sensor 2213, and a 3D sensor 2214, etc., and in addition, an iris sensor, a gyro sensor, a barometric pressure sensor, a magnetic sensor, a grip sensor, a proximity sensor, a color sensor, an Infrared (IR) sensor, a biometric sensor, a temperature sensor, a humidity sensor, and/or an illumination sensor.

The 3D sensor 2214 may sense a shape and movement of an object by irradiating a preset light to the object and analyze light reflected from the object and may include the LiDAR device 1000 described with reference to FIG. 7.

The interface 2277 may support one or more designated protocols that may be used by the electronic device 2201 to connect directly or wirelessly with another electronic apparatus (e.g., the electronic device 2102). The interface 2277 may include one or more of a High Definition Multimedia Interface (HDMI), a Universal Serial Bus (USB) interface, an SD card interface, and/or an audio interface.

The connection terminal 2278 may include a connector through which the electronic device 2201 may be physically connected to another electronic device (e.g., the electronic device 2102). The connection terminal 2278 may include one or more of an HDMI connector, a USB connector, an SD card connector, and/or an audio connector (e.g., a headphone connector).

The haptic module 2279 may convert an electrical signal into mechanical stimulation (vibration and/or movement, etc.) or electrical stimulation that the user may perceive through tactile or kinesthetic senses. The haptic module 2279 may include a motor, a piezoelectric element, and/or an electrical stimulation device.

The camera module 2280 may capture still images and moving images. The camera module 2280 may include a lens assembly including one or more lenses, image sensors, image signal processors, and/or flashes. The lens assembly included in the camera module 2280 may collect light emitted from an object, which is a target of image capture.

The power management module 2288 may manage power supplied to the electronic device 2201. The power management module 2288 may be implemented as part of a Power Management Integrated Circuit (PMIC).

The battery 2289 may supply power to components of the electronic apparatus 2201. The battery 2289 may include a non-rechargeable primary cell, a rechargeable secondary cell, and/or a fuel cell.

The communication module 2290 may establish a direct (wired) communication channel and/or a wireless communication channel between the electronic device 2201 and other electronic devices (the electronic device 2102, the electronic device 2104, the server 2108, etc.), and may support the performance of communication through the established communication channels. The communication module 2290 may include one or more communication processors that operate independently of the processor 2220 (e.g., an application processor) and support direct communication and/or wireless communication. The communication module 2290 may include a wireless communication module 2292 (a cellular communication module, a short-range wireless communication module, a Global Navigation Satellite System (GNSS, etc.) communication module) and/or a wired communication module 2294 (a Local Area Network (LAN) communication module, or a power line communication module, etc.). Among these communication modules, a corresponding communication module may communicate with other electronic devices through the first network 2298 (a short-range communication network, such as Bluetooth, WiFi Direct, or Infrared Data Association (IrDA)) or the second network 2299 (a telecommunication network, such as a cellular network, the Internet, or a computer network (LAN) and WAN, etc.). The various types of communication modules may be integrated into one component (a single chip, etc.) or implemented as a plurality of components (plural chips) separate from each other. The wireless communication module 2292 may identify and authenticate the electronic apparatus 2201 within a communication network, such as the first network 2298 and/or the second network 2299 by using subscriber information (such as, International Mobile Subscriber Identifier (IMSI)) stored in a subscriber identification module 2296.

The antenna module 2297 may transmit or receive signals and/or power to and from the outside (other electronic apparatuses, etc.). The antenna may include a radiator having a conductive pattern formed on a substrate (PCB, etc.). The antenna module 2297 may include one or a plurality of antennas. When a plurality of antennas is included in the antenna module 2297, an antenna suitable for a communication method used in a communication network, such as the first network 2298 and/or the second network 2299 from among the plurality of antennas may be selected by the communication module 2290. Signals and/or power may be transmitted or received between the communication module 2290 and other electronic devices through the selected antenna. In addition to the antenna, other components (an RFIC, etc.) may be included as part of the antenna module 2297.

Some of the components are connected to each other through communication methods between peripheral devices (one or more of a bus, a General Purpose Input and Output (GPIO), a Serial Peripheral Interface (SPI), a Mobile Industry Processor Interface (MIPI), etc.) and may interchange signals (commands, data, etc.).

Commands or data may be transmitted or received between the electronic device 2201 and an external electronic device 2204 through the server 2108 connected to the second network 2299. The other electronic devices 2202 and 2204 may be the same or different types of devices from the electronic device 2201. All or part of operations performed on the electronic device 2201 may be executed on one or more of the other electronic devices 2202, 2204, and 2208. For example, when the electronic apparatus 2201 needs to perform a function or service, the electronic device 2201 may request one or more other electronic devices to perform part or all function or service instead of executing the function or service itself. One or more other electronic devices that have received the request may execute additional functions or services related to the request and transmit results of the execution to the electronic device 2201. For this purpose, cloud computing, distributed computing, and/or client-server computing technologies may be used.

Any or all of the elements described with reference to FIG. 8 may communicate with any or all other elements described with reference to FIG. 8. For example, any element may engage in one-way and/or two-way and/or broadcast communication with any or all other elements in FIG. 8, to transfer and/or exchange and/or receive information such as but not limited to data and/or commands, in a manner such as in a serial and/or parallel manner, via a bus such as a wireless and/or a wired bus (not illustrated). The information may be in encoded various formats, such as in an analog format and/or in a digital format.

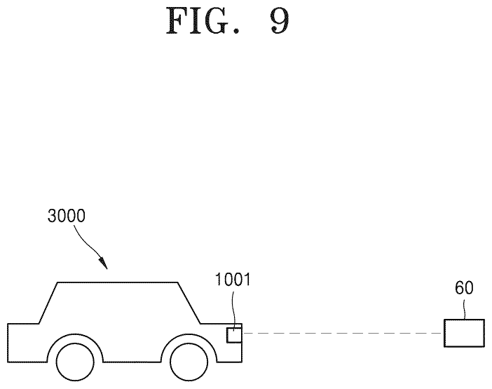

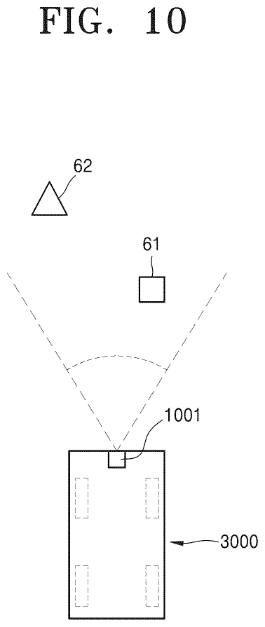

FIGS. 9 and 10 are conceptual diagrams showing a case when a LIDAR device 1001 according to various example embodiments is applied to a vehicle 3000, and are a side view and a top view, respectively.

Referring to FIG. 9, the LiDAR device 1001 may be applied to the vehicle 3000, and information about an object 60 may be obtained using the LiDAR device 1001. The LiDAR device 1000 described with reference to FIG. 7 may be employed as the LIDAR device 1001. The LiDAR device 1001 may use a time-of-flight (TOF) method to obtain information about the object 60. The vehicle 3000 may be a car with an autonomous driving function. Using the LiDAR device 1001, it may be possible to detect objects and/or people, for example, the object 60 in a direction in which the vehicle 3000 travels, and a distance to the object 60 may be measured using information, such as the time difference between a transmitted signal and a detected signal. Also, as shown in FIG. 10, information about a close object 61 and a far subject 62 within a target area TF may be obtained.

FIGS. 9 and 10 illustrate that the LiDAR device 1001 will be applied to a car, but the application is not limited thereto. The LiDAR device may be applied to one or more of flying objects, such as drones, etc., mobile devices, small walking vehicles (e.g., one or more of bicycles, motorcycles, strollers, boards, etc.), robots, human/animal assistive devices (e.g., one or more of canes, helmets, accessories, clothing, watches, bags, etc.), loT (Internet of Things) devices/systems, security devices/systems, etc.

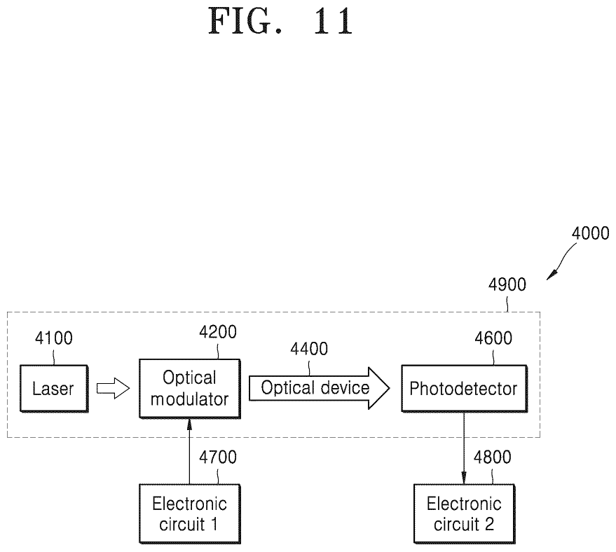

FIG. 11 is a block diagram conceptually showing an example configuration of an optical integrated circuit 4000 according to various example embodiments.

The optical integrated circuit 4000 may include a light source 4100, an optical device 4400 that transmits light from the light source 4100, and a photo detector 4600 that converts the light transmitted through the optical device 4400 into an electrical signal. The optical device 4400 may include any one of the optical devices 100, 101, 102, 103, and 104 described above. The optical device 4400 may include a splitter, a ring resonator, a grating coupler, etc. in addition to a single waveguide.

This structure may be, for example, a part of a circuit that constitutes an optical transceiver. The optical integrated circuit 4000 may further include an optical modulator 4200 disposed in the optical device 4400, an electronic circuit 4700 configured to apply a modulation signal to the optical modulator 4200, and an electronic circuit 4800 to which an electrical signal converted in the photo detector 4600 is transmitted.

The light source 4100, the optical modulator 4200, the optical device 4400, and the photo detector 4600 may be disposed on the same substrate 4900. The substrate 4900 may be a silicon substrate, and the photo detector 4600 may also be a photodiode using a silicon semiconductor.

For example, the light source 4100 may be a laser that emits light in a wavelength range from 1.2 μm to 1.7 μm. To sense light in this wavelength band and convert the light into an electrical signal, a photodiode including a group III-V semiconductor substrate is usually used, but forming such a photodiode on a silicon substrate is very difficult and expensive. As in some example embodiments, an optical integrated circuit 4000 that may utilize the advantages of silicon photonics, for example, a large-capacity information transmission, an ultra-high-speed processing, a minimal transmission loss, and reduced energy consumption may be implemented by applying a silicon-based photodiode capable of sensing light in a wide wavelength band to the photodetector 4600.

The optical device of the disclosure may enable or help to enable efficient optical waveguide by including a third waveguide including a third core having an intermediate refractive index between the first waveguide and the second waveguide. An optical device and the LiDAR device including the same have been described with reference to example embodiments shown in the drawings. It may be understood by those of ordinary skill in the art that various changes in form and details may be made therein without departing from the spirit and scope of the disclosure. Therefore, the embodiments should be considered in a descriptive sense only and not for purposes of limitation. The scope of the disclosure is defined not by the detailed description of the disclosure but by the appended claims, and all differences within the scope will be construed as being included in the disclosure.

According to various example embodiments, an optical device capable of efficient or more efficient light propagation and operation in a wide wavelength range may be provided by including a third core having an intermediate refractive index between a first core and a second core having a difference in refractive index.

Any of the elements and/or functional blocks disclosed above may include or be implemented in processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc. The processing circuitry may include electrical components such as at least one of transistors, resistors, capacitors, etc. The processing circuitry may include electrical components such as logic gates including at least one of AND gates, OR gates, NAND gates, NOT gates, etc.

It should be understood that various embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. An optical device comprising:
a first waveguide including a first core;
a second waveguide spaced apart from the first waveguide and including a second core having a refractive index less than a refractive index of the first core; and
a third waveguide including a third core between the first waveguide and the second waveguide and having a refractive index less than the refractive index of the first core and greater than the refractive index of the second core.

2. The optical device of claim 1, wherein the refractive index of the third core decreases intermittently and/or continuously from an interface where the third waveguide contacts the first waveguide to an interface where the third waveguide contacts the second waveguide.

3. The optical device of claim 1, wherein the third waveguide defines pores inside the third core.

4. The optical device of claim 3, wherein a density of the pores increases intermittently and/or continuously from an interface where the third waveguide contacts the first waveguide to an interface where the third waveguide contacts the second waveguide.

5. The optical device of claim 3, wherein a size of the pores increases intermittently and/or continuously from an interface where the third waveguide contacts the first waveguide to an interface where the third waveguide contacts the second waveguide.

6. The optical device of claim 3, wherein the pores include at least one of nanopores or micropores.

7. The optical device of claim 1, wherein the third core includes at least one of silicon nitride or silicon oxide.

8. The optical device of claim 7, wherein at least one of composition ratio of silicon and nitrogen in the silicon nitride or a composition ratio of silicon and oxygen in the silicon oxide varies with a position in the third waveguide.

9. The optical device of claim 1, wherein the third waveguide further defines pores inside the third core, and the third core includes at least one of silicon nitride or silicon oxide.

10. The optical device of claim 1, wherein the third waveguide has a tapered shape.

11. The optical device of claim 1, further comprising:
an amplifier on at least one of the first waveguide or the third waveguide.

12. The optical device of claim 1, wherein a distance between the first waveguide and the second waveguide is 10 μm or more.

13. The optical device of claim 1, wherein the first core includes at least one of silicon or a Group III-V semiconductor material.

14. The optical device of claim 1, wherein the second core includes at least one of silicon nitride, silicon oxide, zinc oxide or titanium oxide.

15. The optical device of claim 1, wherein the first core includes Si, and the second core includes Si₃N₄. 16 The optical device of claim 1, wherein the first core includes Si and the second core includes SiO₂.

17. An optical integrated circuit comprising:
a substrate; and
an optical device on the substrate,
wherein the optical device includes:
a first waveguide including a first core;
a second waveguide spaced apart from the first waveguide and including a second core having a refractive index less than that of the first core; and
a third waveguide between the first waveguide and the second waveguide and including a third core having a refractive index less than the refractive index of the first core and greater than the refractive index of the second core.

18. A LIDAR device comprising:
a light transmitter configured to irradiate light to an object;
a light receiver configured to receive light reflected from the object;
a processor configured to perform an operation to obtain information about the object from the light received by the light receiver; and
an optical device configured to provide a path for light to travel within the light transmitter and/or the light receiver,
wherein the optical device includes:
a first waveguide including a first core;
a second waveguide spaced apart from the first waveguide and including a second core having a refractive index less than a refractive index of the first core; and
a third waveguide between the first waveguide and the second waveguide and including a third core having a refractive index less than the refractive index of the first core and greater than the refractive index of the second core.

19. The LiDAR device of claim 18, wherein the refractive index of the third core decreases intermittently or continuously from an interface where the third waveguide contacts the first waveguide to an interface where the third waveguide contacts the second waveguide.

20. The LiDAR device of claim 18, wherein the third waveguide defines pores inside the third core.
